(19) United States
(12) Patent Application Publication
(10) Pub. No.: US 2004/0257464 A1
(43) Pub. Date: Dec. 23, 2004

(54) Camera tripold with memory storage and power source

(76) Inventors: Amol S. Pandit, Greeley, CO (US); Daniel J. Byrne, Fort Collins, CO (US); Jeffery B. Beemer, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/600,876

(22) Filed: Jun. 20, 2003

(51) Int. Cl. H04N 5/225

(52) U.S. Cl. 348/373; 348/372

(57) ABSTRACT

The present invention extends one or both of memory capacity and battery capacity of a digital camera. A camera tripod includes a tripod memory, a camera mount, and a set of legs that supports the camera mount. The camera tripod may further include a tripod power source. The camera mount electrically interfaces a digital camera to the tripod memory and optionally to the tripod power source. A method of using a camera tripod with a digital camera includes connecting the digital camera to the camera mount to interface the tripod memory to the digital camera, and transferring data between a memory of the connected digital camera and the tripod memory. The method may further include interfacing to the tripod power source to transfer energy to the connected digital camera that one or both of recharges a battery of the digital camera and powers the digital camera.

### TECHNICAL FIELD

The invention relates to electronic devices. In particular, the invention relates to digital cameras and to memory and a battery used with digital cameras.

### BACKGROUND OF THE INVENTION

Digital cameras, cameras that record captured images as digital image files in a memory of the camera, are an attractive alternative to conventional, film-based cameras. In particular, recent advances in image resolution and rapid reductions in unit price have resulted in a rapid adoption of digital cameras as the method of choice for recording images by camera users. The attractiveness of digital cameras to the camera user is due in large part to the absence of film and the associated film processing and printing that comes with using film. With digital cameras, a captured image may be viewed immediately after capture. Moreover, the images can be printed using conventional printers and/or distributed electronically over the Internet using email or posted on a website with relative ease.

Most digital cameras employ one or both of internal memory or removable memory to store digital image files of the captured images. Internal memory is memory that is built into the digital camera. Removable memory is memory that can be readily removed from the digital camera. Examples of removable memory used with digital cameras include, but are not limited to, computer diskettes, ram disks and a variety of memory cards.

Regardless of whether a given camera employs internal or removable memory, or both, a number of images that may be captured and stored by the digital camera is ultimately limited by a memory capacity of the available memory. Memory capacity is often an even more critical limiting factor for digital cameras having a high resolution image capture capability since high resolution images result a significantly higher memory usage per stored image than lower resolution images. In addition to memory capacity, energy limitations associated with finite amounts of energy that can be stored in batteries used to operate the camera also may limit the number of images that may be captured and stored. Thus, a user of a digital camera must often carry additional removable memory cards and sometimes additional batteries and/or a battery charging device. Carrying additional memory cards and batteries is especially important when traveling with the camera for an extended period of time away from a home base where resources exist for downloading and archiving images and for recharging the batteries.

Unfortunately, the need to carry additional, spare memory cards and/or backup batteries or battery packs may be taxing for the typical digital camera user. In addition to the extra space and weight that such items require, the user must also remember to pack the spare memory cards and battery packs before leaving home.

Accordingly, it would be advantageous to have a way to increase a memory capacity and thus a number of images that may be captured by a digital camera without requiring the user to carry spare memory cards. In addition, a way to provide additional power to operate the digital camera beyond a limit set by a capacity of the camera battery would be advantageous. Such a potentially expanded memory capacity and an extended power supply capability would solve a long-standing need in the area of digital cameras.

### SUMMARY OF THE INVENTION

The present invention extends a memory capacity of a digital camera without requiring the use of removable memory. In addition, the present invention may provide additional battery capacity, such that a usage time of the digital camera is extended. In particular, according to the present invention, a camera tripod that has memory storage and/or a power source provides the extended memory capacity and/or additional battery capacity for the digital camera according to the present invention.

In an aspect of the present invention, a camera tripod having memory storage for a digital camera is provided. In particular, the memory storage is in addition to a memory storage of the digital camera. The camera tripod comprises a camera mount, a tripod memory housed in the camera mount, and a set of tripod legs that supports the camera mount. The camera mount is adapted to mechanically and electrically interface to a digital camera. The tripod memory is connected to an electrical portion of the camera mount such that the tripod memory is accessible to the digital camera to enable digital image files from the camera to be stored in the tripod memory.

In another aspect of the present invention, a camera tripod for a digital camera having both memory storage and energy storage is provided. In particular, the memory storage is in addition to memory storage of the digital camera and the energy storage is in addition to a power source of the digital camera. The camera tripod comprises a camera mount, a tripod memory housed in the camera mount, a set of tripod legs that supports the camera mount, and a tripod power source housed in either the camera mount or a leg of the set of tripod legs. The camera mount is adapted to both mechanically and electrically interface to the digital camera. Both the tripod memory and the tripod power source are connected to an electrical portion of the camera mount such that the tripod memory and the tripod power source are accessible to the digital camera through the camera mount. Energy stored by the tripod power source is transferred to the digital camera to one or both of operate the digital camera and recharge a battery of the digital camera.

In another aspect of the invention, a method of using a camera tripod for one or both of memory storage and a power source in addition to using the camera tripod for support of a digital camera is provided. The method of using a camera tripod with a digital camera comprises connecting the digital camera to a camera mount of the camera tripod. The camera mount comprises an electrical portion having a tripod memory, wherein connecting comprises interfacing the digital camera to the tripod memory. The method further comprises transferring data between a memory of the connected digital camera and the tripod memory of the camera mount.

Certain embodiments of the present invention have other features in addition to and in lieu of the features described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a block diagram of a camera tripod having memory storage for use with a digital camera according to an embodiment of the present invention.

FIG. 2A illustrates a perspective view of an exemplary camera tripod according to an embodiment of the present invention.

FIG. 2B illustrates a perspective view of an exemplary camera tripod having a camera mount, the mechanical portion of which resembles a camera docking station according to an embodiment of the present invention.

FIG. 3 illustrates a block diagram a camera tripod having a battery-based power source according another embodiment of the present invention.

FIG. 4 illustrates a method of using a camera tripod having one or both of memory storage and a power source with a digital camera.

### MODES FOR CARRYING OUT THE INVENTION

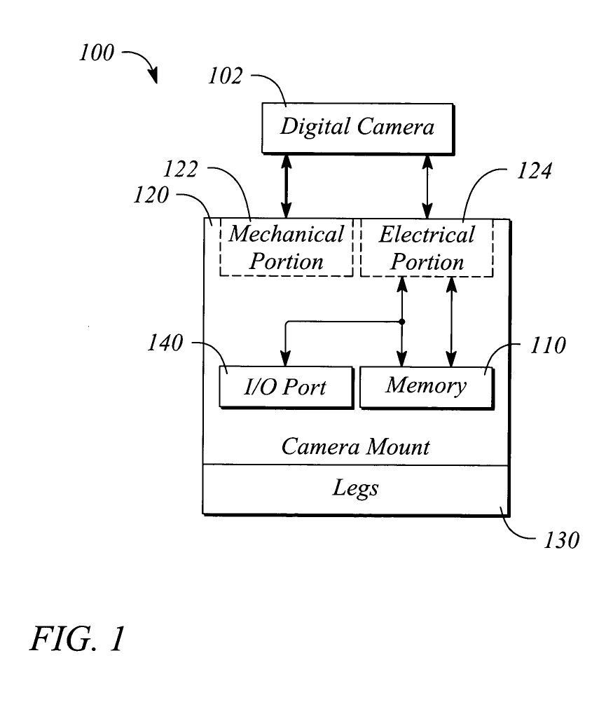

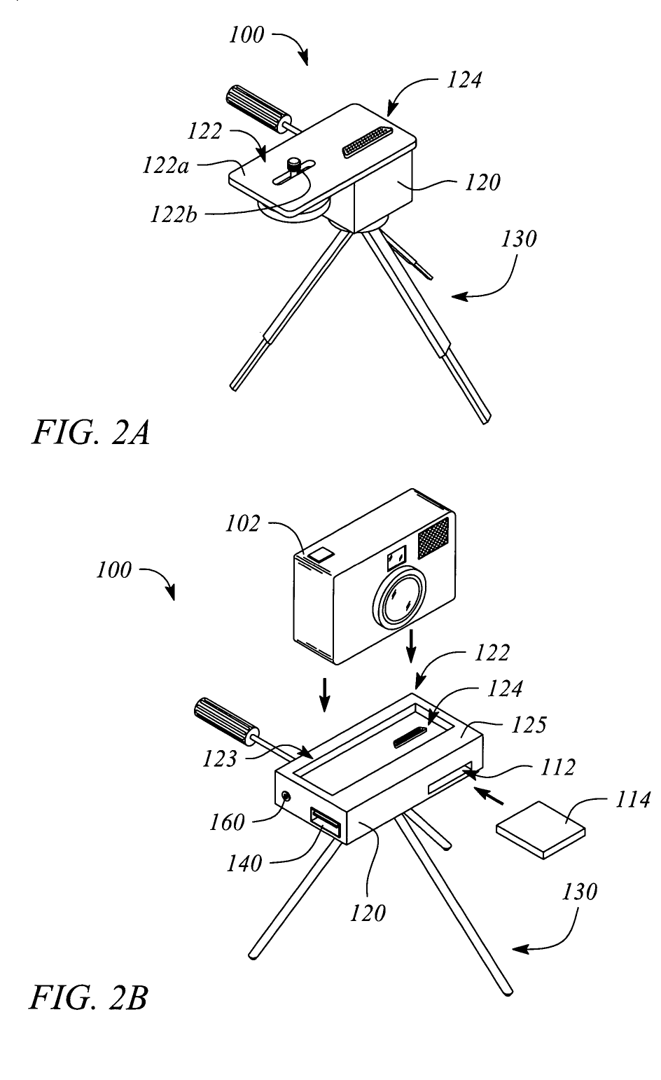

FIG. 1 illustrates a block diagram of a digital camera tripod 100 having memory storage for use with a digital camera 102 according to an embodiment of the present invention. FIGS. 2A and 2B illustrate perspective views of exemplary embodiments of the digital camera tripod 100 illustrated in FIG. 1. The digital camera tripod 100 is used to mount and hold or support the digital camera 102. In particular, the digital camera 102 may be mounted to and supported by the digital camera tripod 100 while the digital camera 102 captures images.

With respect to mounting and holding, the camera tripod 100 is essentially similar to a conventional tripod used with a camera. However, unlike a conventional tripod, the camera tripod 100 of the present invention provides memory storage that is in addition to the memory storage capability of the digital camera 102. While mounted or held by the camera tripod 100, the digital camera 102 can employ the tripod memory storage capability to store digital image files from the digital camera 102 according to the present invention. Accordingly, an image file storage capacity of the digital camera 102 is increased compared to an image file storage capacity of the digital camera 102 alone, when the memory storage capability the camera tripod 100 of the present invention is employed.

The camera tripod 100 comprises means for storing data or a tripod memory 110. The memory 110 is adapted to receive and store digital image files from the digital camera 102 when mounted to the camera tripod 100. The memory 110 may also receive and store other data from the digital camera 102. Moreover, the tripod memory 110 may transfer digital image files and/or the other data stored in the memory 110 to the digital camera 102.

The tripod memory 110 is one or both of internal memory and removable memory. By ‘internal memory’ it is meant that the memory that stores data is built into and intended to remain within the camera tripod 100. In other words, internal memory is not removed from the camera tripod 100 under typical conditions of use. For example, internal memory may be memory installed on a circuit board that is internal or integral to the camera tripod 100.

By ‘removable memory’ it is meant that the memory 110, or a portion thereof, which stores image files and/or other data, may be readily removed from the camera tripod 100 under normal use conditions. For example, the removable memory may be memory configured as a removable card that plugs into an externally accessible port or slot in the camera tripod 100.

For example, the tripod memory 110 in the form of internal memory may be random access memory (RAM), flash memory, or a combination thereof. Flash memory, memory, usually based on some form of an electrically erasable programmable read-only memory (EEPROM), is preferred for the memory 110, since such flash memory does not require a constant source of power to retain data stored therein. Battery-backed RAM, that is RAM having an associated battery that maintains stored data in the absence of a constant power source, may be employed instead of or in addition to flash memory for the tripod memory 110. For the purposes of discussion herein, and not by way of limitation, ‘battery-backed RAM’ and ‘flash memory’ are used interchangeably herein since the battery of battery-backed RAM provides such RAM with an ability similar to flash memory to maintain stored data without a constant source of power. In some embodiments where a power source is available or where maintenance of image files in the absence of a constant power source is not necessary, conventional RAM may be used for the tripod memory 110. In yet other embodiments, a disk drive built into the camera tripod 100 may be employed to realize a portion of or even all of the memory 110.

Examples of removable memory include, but are not limited to, removable media disk drives (e.g., CD/DVD disks), removable disk drives (e.g., PCMCIA card hard disks), so-called ‘ramdisk’ modules, and various flash memory cards. An exemplary memory card slot 112 and an associated exemplary removable memory card 114 of the removable form of the memory 110 are illustrated in FIG. 2B. Removable flash memory cards applicable to the present invention include, but are not limited to, a Compact Flash® Type I or Compact Flash® Type II card, a Memory Stick®, a SmartMedia® Card, a Secure Digital® Card, a XD-Picture® Card and a PC card. CompactFlash® is a registered trademark of Sandisk Corporation, Santa Clara, California. Memory Stick® is a registered trademark of Sony Kabushiki Kaisha TA, Sony Corporation, Tokyo, Japan. SmartMedia® and Secure Digital® are a registered trademarks of Kabushiki Kaisha Toshiba DBA, Toshiba Corporation, Japan. XD-Picture® Card is a registered trademark of Fuji Photo Film Co., Ltd., Japan. PC Cards are ‘credit card’-size peripherals that add memory, mass storage, and input/output (I/O) capabilities in a rugged, standardized, compact form factor to computers and other similar electronic devices. The PC cards, also known as PCMCIA cards, are manufactured by a large number of memory product companies. The acronym ‘PCMCIA’ stands for the Personal Computer Memory Card International Association, a non-profit trade association and standards body that promotes PC Card technology. One skilled in the art is familiar with internal and removable memory used to receive and store digital image files produced by digital cameras. All such memory is within the scope of the present invention.

In some embodiments, power to operate the tripod memory 110 may be provided by the digital camera 102, for example. In other words, a power supply, such as a battery, of the digital camera 102 can serve as an energy source to activate and operate the tripod memory 110 when the digital camera is mounted to the camera tripod 100. In other embodiments specifically described hereinbelow, another source of power may be employed to power the tripod memory 110. In particular, the power source may be built into the camera tripod 100. In yet other embodiments, the source of power may be external to both the camera tripod 100 and the digital camera 102, such as a conventional AC outlet or an auxiliary DC power port in an automobile or an airplane.

The camera tripod 100 further comprises a camera mount 120. The camera mount 120 mechanically mounts and electrically interfaces to the digital camera 102. In particular, the camera mount 120 comprises a mechanical portion 122 that provides means for mechanically holding or securing the digital camera 102 mounted thereto. A heavy double-headed arrow between the mechanical portion 122 and the digital camera 102 represents ‘holding and securing’ as illustrated in FIG. 1. The camera mount 120 further comprises an electrical portion 124 that provides a means for electrically interfacing to the digital camera 102 mounted thereto. A double-headed arrow from the electrical portion 124 to the camera 102 represents ‘electrically interfacing’ as illustrated in FIG. 1.

The mechanical portion 122 of the camera mount 120 may be realized in a variety of ways, all of which are within the scope of the present invention. FIG. 2A illustrates a perspective view of an exemplary camera tripod 100 according to an embodiment of the present invention. As illustrated in FIG. 2A, the mechanical portion 122 comprises a plate 122a and a threaded screw 122b. The threaded screw 122b mates with and screws into a thread receiver (not illustrated) in the digital camera 102. When tightened, the screw 122b holds the digital camera 102 in contact with the plate 122a thereby securing and holding the digital camera 102. The ‘plate and screw’ style mechanical portion 122 of the camera mount 120 is essentially similar to a conventional camera mount of a conventional camera tripod.

In another example, the mechanical portion 122 of the camera mount 120 may resemble a camera docking station used in conjunction with the digital camera 102. FIG. 2B illustrates an exemplary camera tripod 100 having a camera mount 120, the mechanical portion 122 of which resembles a camera docking station according to an embodiment of the present invention. In particular as illustrated in FIG. 2B, the mechanical portion 122 comprises a depression or recess 123 in a surface 125 of the camera mount 120. The recess 123 is adapted to a shape of a portion of the mounted digital camera 102 that is adjacent to the camera mount 120. Friction between the recess 123 and the mounted camera 102 secures the digital camera 102 in place. Optionally, a specialized mechanism may be used to assist in securing the mounted camera 102 into the recess 123 in addition to or instead of friction. For example, a catch, a latch, or a ball-detent mechanism may be employed.

In another exemplary embodiment, the mechanical portion 122 comprises a set of flanges (not illustrated) extending from the surface of the camera mount 120. In particular, the flanges are adapted to hold and secure the mounted camera 102. The flanges may be employed in conjunction with the recess 123 to secure the digital camera 102 in some embodiments. As such, the mechanical portion 122 may resemble a mechanical portion of a camera docking station according to some embodiments of a present invention.

In yet another embodiment, the mechanical portion 122 comprises a clamp (not illustrated) that contacts and presses against one or more sides of the mounted digital camera 102 and/or a clip (not illustrated) that snaps into a recess in the mounted digital camera 102 to secure and hold the digital camera to the camera mount 120. In yet other embodiments, a connector of the electrical portion 124 (described further below), when engaged in a mating connector of the digital camera 102, may comprise all or part of the mechanical portion 122. In particular, friction of the mating of the connectors may be sufficient to secure the camera 102 to the camera mount 120. One skilled in the art may readily devise many configurations of the mechanical portion 122 including ones not specifically listed hereinabove. All such configurations of the mechanical portion 122 are within the scope of the present invention.

The electrical portion 124 of the camera mount 120 comprises means for interfacing with the digital camera 102, the means for interfacing facilitating an exchange of data between the digital camera 102 and the camera tripod 100. For example, the electrical portion 124 may be an electrical connector. The electrical connector is adapted to mate with a similar or complementary electrical connector of the digital camera 102. For example, a conventional multi-pin connector, such as a standard universal serial bus (USB) connector or a standard ‘D-connector’, may be employed as the electrical portion 124 of the camera mount 120. Alternatively, a custom or non-standard multi-pin connector may be used. One skilled in the art is familiar with a wide variety of electrical connectors, many of which are used in conjunction with digital cameras 102, and all of which are within the scope of the electrical portion 124 of the present invention.

In other embodiments, the electrical portion 124 comprises a wireless or optical interface instead of or in addition to the electrical connector. Examples of the wireless interface that may be employed as the electrical portion 124 include, but are not limited to, an IEEE 802.11 (WiFi) interface and a Bluetooth wireless interface. Examples of the optical interface include, but are not limited to, an infrared data association (IrDA) infrared data interface used with many personal computers (PCs) and printers. In such embodiments, the electrical portion 124 communicates either wirelessly or optically with a similar or complementary interface of the mounted digital camera 102.

As mentioned hereinabove, the electrical portion 124 of the camera mount 120 functions as a data interface between the camera tripod 100 and the digital camera 102. In particular, the memory 110 of the camera tripod 100 is connected to the electrical portion 124 of the camera mount 120. The digital camera 102 communicates with the camera tripod 100 through the electrical portion 124. Specifically, digital image files are passed or transferred between the digital camera 102 and the memory 110 of the camera tripod 100 by way of the data interface of the electrical portion 124 of the camera mount 120.

The camera tripod 100 further comprises means for supporting or a set of legs 130 that connect to and support the camera mount 120 and digital camera 102 when mounted thereto. The set of legs 130 is essentially similar to a set of legs of a conventional camera tripod. Preferably, the set of legs 130 comprises three legs. However, the set of legs 130 may comprise any number of legs including, but not limited to, one, two, three, four, and five legs. The legs of the set of legs 130 may be fixed or foldable. Furthermore the legs of the set of legs 130 may have a fixed length or may have an adjustable length.

In some embodiments, the camera tripod 100 may further comprise an input/output (I/O) interface or port 140. The I/O port 140 is connected to one or both of the memory 110 and the electrical portion 124 of the camera mount 120. The I/O port 140 provides an interface between the camera tripod 100 and an external device or system (not illustrated). The external device may be a printer or a personal computer (PC), for example. Using the I/O port 140, digital image files and other data may be transferred between the camera tripod 100 and the external device or system. In addition, digital image files and other data may be transferred between the mounted digital camera 102 and the external device or system by way of the electrical portion 124 of the camera mount 120 using the I/O port 140.

Examples of the I/O port 140 include, but are not limited to, USB, Ethernet, and conventional parallel or serial printer interfaces. In addition, the I/O interface 140 may be a wireless interface such as, but not limited to, WiFi or an optical interface such as, but not limited to IrDA infrared data interface. For example, the I/O port 140 may emulate an I/O interface of the digital camera 102. Thus, if the camera 102 employs a USB I/O interface, the I/O port 140 preferably is a USB I/O interface.

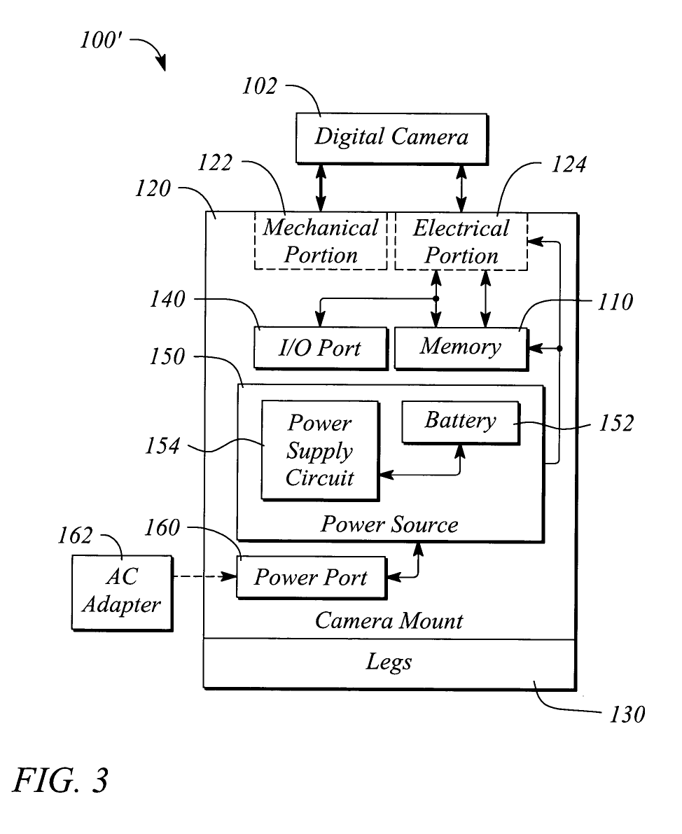

FIG. 3 illustrates a block diagram a camera tripod 100′ having a power source according another embodiment of the present invention. The camera tripod 100′ comprises all of the elements of the camera tripod 100 described hereinabove. In particular, the camera tripod 100′ comprises the memory 110, the camera mount 120, and the set of legs 130. In some embodiments the camera tripod 100′ further comprises the I/O port 140 of the camera tripod 100.

The camera tripod 100′ further comprises means for supplying power or a power source 150. The power source 150 supplies power to operate the tripod memory 110. In some embodiments, the power source 150 may further supply power to operate the mounted digital camera 102. In addition, the power source 150 may charge a battery of the digital camera 102 while the digital camera 102 is mounted to the camera tripod 100′. In some embodiments, the camera tripod 100′ may further comprise a power port 160. When present, the power port 160 is connected to the power source 150. In some cases, the power port 160 may be connected to the electrical portion 124 of the camera mount 120 in addition to or instead of being connected to the power source 150.

The power source 150 comprises a battery 152. The battery 152 is connected to the electrical portion 124 of the camera mount 120. Energy stored by the battery 152 is transferred to the mounted digital camera 102 by way of the electrical portion 124. Thus with respect to the camera tripod 100′, the electrical portion 124 of the camera mount 120 provides a power interface as well as a data interface.

In particular, the electrical portion 124 may comprise a single multi-pin connector 124, one or more pins of which are employed to transfer energy from the battery 152 to the mounted camera 102. In other embodiments, the electrical portion 124 may comprise a multi-pin connector that serves as a data interface as described hereinabove with respect to the camera tripod 100. The electrical portion 124 may further comprise a power connector (not illustrated) that serves as the power interface. One skilled in the art may readily devise other configurations of the electrical portion 124 capable of serving as both a data interface and a power interface. All such other configurations are within the scope of the present invention.

The battery 152 may be a non-rechargeable or a rechargeable battery type. For example, the battery 152 may be a non-rechargeable alkaline battery. If a non-rechargeable battery 152 is employed, the battery 152 is preferably mounted in the camera tripod 100′ in a manner that facilitates easy removal and replacement of the battery 152 when it is drained of useable energy. For example, the battery 152 may be mounted in a compartment of the camera mount 120, the compartment being accessed by way of a door or hatch in a surface of the camera mount 120.

Preferably however, the battery 152 is a rechargeable battery such as, but not limited to, a nickel-cadmium (NiCd), a nickel-metal hydride (NiMH), or a lithium (Li) ion battery. The rechargeable battery 152 may be recharged by an external power source such as an AC power outlet while housed in the camera tripod 100′. Alternatively, the rechargeable battery 152 may be removed from the camera tripod 100′ for recharging. Referring again to FIG. 3, an AC adapter 162 connected to the power port 160 may be used to recharge the battery 152 using a conventional AC power outlet, depending on the embodiment.

As mentioned hereinabove, the battery 152 may be mounted in the camera mount 120. Alternatively, the battery 152 may be located in one or more of the legs of the set of legs 130. One skilled in the art may readily devise various locations for the battery 152. All such locations are within the scope of the present invention.

The battery-based power source 150 optionally may further comprise a power supply circuit 154. The power supply circuit 154 is located between the power port 160 and the battery 152 to provide, in part, regulation or control of charging the battery 152 using the power port 160 connected to and external power source (e.g., using the AC adapter 162), for example. Alternatively or in addition, the power supply circuit 154 may be located between the battery 152 and the electrical portion 124 of the camera mount 120 to provide power conditioning and/or regulation of power used to power the tripod memory 110 and/or power conditioning and/or regulation of power transferred to the digital camera 102.

For example, the power supply circuit 154 comprises a battery charger/conditioner (not illustrated). The battery charger/conditioner monitors a condition of the battery 152 during charging using power from the external power source. Preferably, the battery charger/conditioner provides optimized recharging of the battery 152 as well as provides ability to condition the battery 152 to extend operational life of the battery 152. In addition, the battery charger/conditioner may convert and regulate a voltage and/or a current received from the external power source by way of the power port 160. For example, the battery charger/conditioner may be a MAX1757 Stand-Alone, Switch-Mode Li+Battery Charger marketed by Maxim Integrated Products, Sunnyvale, Calif., USA. One skilled in the art can readily make a suitable choice of a specific battery charger/conditioner for use in the power supply circuit 154 without undue experimentation.

In another example, the power supply circuit 154 comprises a power conditioner (not illustrated) that conditions power extracted from the battery 152. In particular, the power condition may convert a voltage and/or a current of the battery 152 into one or more different voltages and or currents. One of the different voltages may be adapted to power the memory 110 of the camera tripod 100′, for example. Another may be adapted to power the digital camera 102 and/or to charge the battery of the digital camera 102. Thus for example, the power conditioner of the power supply circuit 154 may be a DC-DC converter. The DC-DC converter may be any of the various DC-DC converters known in the art including, but not limited to, linear regulators, switching regulators and converters, and charge pump converters. For example, the DC-DC converter may be a MAX679 Step Up Regulated Charge Pump Converter marketed by Maxim Integrated Products, Sunnyvale, Calif., USA. The choice of a specific DC-DC converter for a given camera tripod 100′ and/or specific digital camera 102 is dependent on specifics of the memory 110 of the camera tripod 100′ and the digital camera 102. One skilled in the art can readily make such a choice without undue experimentation.

In yet another example, the power supply circuit 154 may comprise both a battery conditioner/charger and a power conditioner. Thus, the power supply circuit 154 both provides regulation of charging of the battery 152 and conditioning of power extracted from the battery 152.

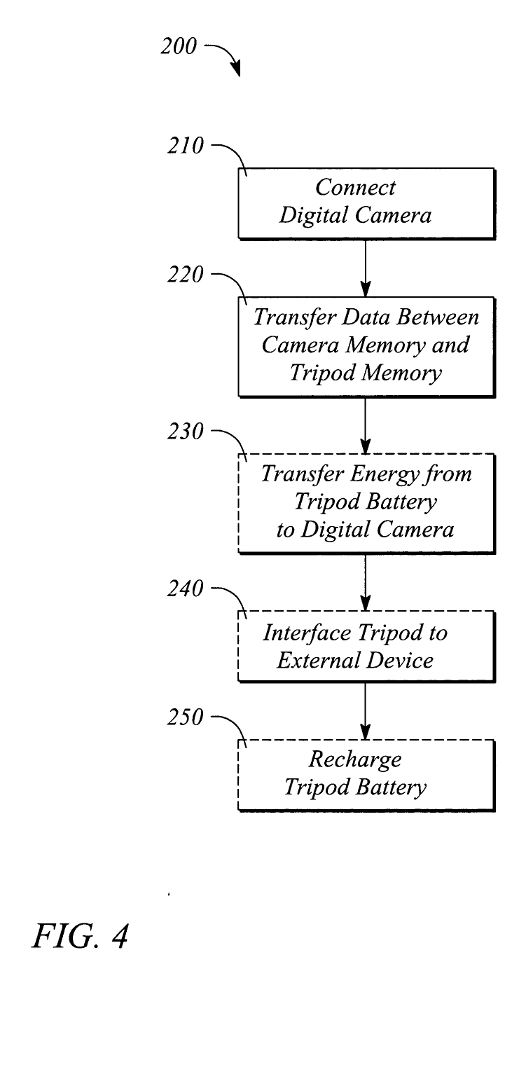

FIG. 4 illustrates a method 200 of using a camera tripod for one or both of memory storage and a power source in addition to using the camera tripod for support of a digital camera according to an embodiment of the present invention. The method 200 comprises connecting 210 the digital camera to a camera mount of the camera tripod. Connecting 210 comprises mating together or interfacing complementary electrical connectors as well as mechanical fasteners on the digital camera and the camera mount. For example, an electrical connector of the digital camera may be mated with an electrical connector of the camera mount to form an electrical interface and/or a data interface between the digital camera and a tripod memory. Then, a screw of the camera mount is screwed into a threaded receiver on the digital camera to mechanically fasten the digital camera to the camera tripod by way of the camera mount.

The method 200 further comprises transferring 220 data between a memory of the digital camera and the memory of the camera tripod. The data may be a digital image file or other data that is stored in the digital camera memory. The digital image file may be transferred 220 from the digital camera memory to the camera tripod memory to essentially free up memory space in the digital camera memory. The freed-up memory space may be used to store an additional digital image file created by capturing an additional image with the digital camera, for example. Alternatively, the digital image file may be transferred 220 from the camera tripod memory to the digital camera memory. Thus, the camera tripod memory may provide archival storage of image files for the digital camera. In addition to digital image files, other data such as, but not limited to, directory listings and camera status information, may be transferred 220 between the digital camera memory and the camera tripod memory. One skilled in the art is familiar with a variety of means for transferring data as used in transferring 220 that employ one or both of a parallel and a serial protocol. All such means for transferring and transfer protocols are within the scope of the present invention.

In some embodiments, the method 200 of using the camera tripod further comprises transferring 230 energy from a power source of the camera tripod to the connected 210 digital camera. The transferred 230 energy may be used to one or both of charge a battery of the connected 210 digital camera and provide operational power to the connected 210 digital camera.

In some embodiments, the method 200 of using the camera tripod may further comprise interfacing 240 the camera tripod with an external device or system. For example, the camera tripod is interfaced 240 to a PC and/or a printer. While interfaced 240, a digital image file from the connected 210 digital camera may be transferred to the PC and/or printed using the printer, for example. In another example, while the camera tripod is interfaced 240, a digital image file stored in the camera tripod memory may be transferred to the PC and/or printed using the printer. Note that the digital camera need not remain connected 210 to the camera tripod during interfacing 240 with the external device or system to transfer or print a digital image file stored in the camera tripod memory. As such, the camera tripod may serve as essentially a temporary storage of digital image files of the digital camera prior to interfacing 240 with the external device or system. Moreover, during interfacing 240, digital image files and/or other data may be transferred from the external device to the camera tripod memory and/or to the memory of the connected 210 digital camera.

In some embodiments, the method 200 of using the camera tripod may further comprise recharging 250 a battery-based power source of the camera tripod. In particular, the tripod battery may be directly recharged 250 using an external power source such as, but not limited to, a conventional AC outlet or an auxiliary power port of an automobile or airplane. For example, an AC adapter may be connected to the camera tripod and plugged into an AC output to recharge 250 the tripod battery. Alternatively, the tripod battery may be recharged 250 by simply replacing the tripod battery with another charged battery. This is particularly useful when the tripod battery is a non-rechargeable battery.

One or more of the following features and/or advantages may be realized by the present invention. The tripod computer memory may essentially extend a number of images that may be captured and stored by the digital camera mounted or interfaced to the tripod. In particular, the tripod computer memory provides additional storage space for image files, such that a need for carrying spare memory cards for the digital camera is reduced. In addition, the tripod battery-based power source is available to extend an operational time of the digital camera. Since camera users often carry a tripod, the camera tripod of the present invention may present a somewhat smaller burden to the user than carrying spare memory cards and/or spare batteries. Moreover, according to the present invention, the tripod having memory storage and a power source (i.e., battery) may be used in conjunction with spare memory cards and/or spare batteries to further extend the number of images that may be captured by the digital camera.

Thus, there have been described a camera tripod 100, 100′ that has one or both of tripod memory storage and a battery-based tripod power source. In addition, a method 200 of using a camera tripod to provide one or both of additional memory storage and a power source to a digital camera mounted thereon has been disclosed. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A camera tripod for a digital camera comprising:
a camera mount;
tripod memory housed in the camera mount; and
a set of tripod legs that supports the camera mount.

2. The camera tripod of claim 1, wherein the tripod memory provides memory storage for the digital camera in addition to a memory of the digital camera.

3. The camera tripod of claim 1, wherein the camera mount comprises an electrical portion that electrically interfaces to the digital camera, the tripod memory being connected to the electrical portion such that the tripod memory is accessible to the digital camera.

4. The camera tripod of claim 3, wherein the camera mount further comprises an input/output (I/O) port that electrically interfaces the electrical portion to an external device or system.

5. The camera tripod of claim 3, wherein the camera mount further comprises a mechanical portion that mechanically interfaces to the digital camera to fasten the digital camera to the camera tripod.

6. The camera tripod of claim 1, wherein when the digital camera is electrically interfaced to the camera mount, data is transferred between a camera memory of the digital camera and the tripod memory.

7. The camera tripod of claim 1, further comprising:
a tripod power source housed in one or both of the camera mount and in a leg of the set of tripod legs.

8. The camera tripod of claim 7, wherein the tripod power source provides power to the digital camera in addition to a battery-based power source of the digital camera, the tripod power source providing power to the digital camera to extend an operational life of a battery of the digital camera.

9. The camera tripod of claim 7, wherein the tripod power source comprises a tripod battery selected from a rechargeable type battery and a non-rechargeable type battery.

10. The camera tripod of claim 7, wherein the camera mount comprises an electrical portion that electrically interfaces to the digital camera, the tripod power source and the tripod memory being connected to the electrical portion such that the tripod power source and the tripod memory are accessible to the digital camera.

11. The camera tripod of claim 10, wherein the tripod power source provides one or both of operational power to the digital camera and energy to recharge a battery of the digital camera when the digital camera is electrically interfaced to the camera mount.

12. A camera tripod for a digital camera comprising:
a camera mount;
a tripod memory housed in the camera mount;
a set of tripod legs that supports the camera mount; and
a tripod power source housed in either the camera mount or a leg of the set of tripod legs.

13. The camera tripod of claim 12, wherein the camera mount comprises an electrical portion that electrically interfaces to the digital camera, the tripod memory and the tripod power source being connected to the electrical portion such that the tripod memory and the tripod power source are accessible to the digital camera.

14. The camera tripod of claim 13, wherein the camera mount further comprises a mechanical portion that mechanically interfaces to the digital camera to fasten the digital camera to the camera tripod.

15. The camera tripod of claim 12, wherein the tripod memory provides memory storage to the digital camera in addition to a memory of the digital camera, and wherein the tripod power source provides one or both of operational power to the digital camera in addition to a power source of the digital camera and energy to recharge a battery of the digital camera power source.

16. The camera tripod of claim 12, wherein the tripod power source comprises a tripod battery selected from a rechargeable type battery and a non-rechargeable type battery, the tripod power source providing power to operate the tripod memory.

17. The camera tripod of claim 16, wherein the tripod power source further comprises a power supply circuit that comprises one or more of a battery conditioner, a battery charger and a power conditioner, the power supply circuit facilitating one or more of charging the tripod battery, powering the tripod memory, powering the digital camera and charging a battery of the digital camera.

18. The camera tripod of claim 12, further comprising a tripod power port connected one or both to the tripod power source and an electrical portion of the camera mount, the tripod power port optionally comprises an alternating current (AC) adapter that interfaces the tripod power source to an external AC power outlet.

19. A method of using a camera tripod with a digital camera comprising:
connecting the digital camera to a camera mount of the camera tripod, the camera mount comprising an electrical portion having a tripod memory, wherein connecting comprises interfacing the digital camera to the tripod memory; and
transferring data between a memory of the connected digital camera and the tripod memory of the camera mount.

20. The method of claim 19, wherein the electrical portion of the camera mount further has a tripod battery, connecting further comprises interfacing the digital camera to the tripod battery, the method further comprising one or more of:
transferring energy from the tripod battery the connected digital camera, wherein the transferred energy is used to one or both of charge a battery of the digital camera and provide operational power to the digital camera;
interfacing the camera tripod with an external device, such that data is transferred between the external device and one or both of the memory of the connected digital camera and the tripod memory; and
recharging the tripod battery using one of an external power source and a replacement tripod battery.

21. A camera tripod for a digital camera comprising:
a camera mount;
means for storing data in the camera mount; and
means for supporting the camera mount.

22. The camera tripod of claim 21, wherein when the digital camera is interfaced to the camera mount, data is transferred between a camera memory of the digital camera and the means for storing.

23. The camera tripod of claim 21, further comprising:
means for supplying power housed in one or both of the camera mount and the means for supporting, the means for supplying power energizing one or more of the digital camera and a battery of the digital camera when interfaced to the camera mount and the means for storing.

24. The camera tripod of claim 23, wherein the means for supplying power comprises a battery selected from a rechargeable type battery and a non-rechargeable type battery.

25. The camera tripod of claim 21, wherein the means for storing data comprises one or both of internal memory and removable memory.
